(19) United States
(12) Patent Application Publication
(10) Pub. No.: US 2017/0228725 A1
(43) Pub. Date: Aug. 10, 2017

(54) APPARATUS, SYSTEM AND METHOD OF TOKENISATION OF PAYMENT CARD DATA

(71) Applicant: Emo Oil Ltd, Co. Laois (IE)

(72) Inventors: Benjamin Marcus JORDAN, Leeds (GB); Niklas Olov STENSON, Aby (SE)

(73) Assignee: Emo Oil Ltd, Co. Laois (IE)

(21) Appl. No.: 15/501,917

(22) PCT Filed: Oct. 6, 2015
(86) PCT No.: PCT/EP2015/073061

§ 371 Date: Feb. 6, 2017

(30) Foreign Application Priority Data
Oct. 6, 2014 (GB) 1417624.2

(51) Int. Cl. G06Q 20/38; G06Q 30/02; G06Q 20/10

(52) U.S. Cl. CPC G06Q 20/385; G06Q 20/10; G06Q 30/0226

(57) ABSTRACT

An apparatus for processing payment card data is disclosed (106). The apparatus comprises a tokenisation module (212) operative to generate a token from payment card data, the tokenisation module complying with a security requirement for payment cards; and a registration module (218) operative to transmit the token to a token store for storage therein, the token store being external to the tokenisation module (212). Such apparatus may utilise existing secure payment card processing apparatus to generate tokens. There is also disclosed a system for storing a token and associating a user's personal details with the token together with a method for generating a token and storing it with a user's personal details.

### FIELD

The present invention relates to an apparatus, system and method for processing payment card data. In particular, but not exclusively, the present invention relates to tokenisation of payment card data and an apparatus, system and method for generating and storing tokens together with personal data.

### BACKGROUND

Payment systems for goods and services using a payment card such as a credit account card or debit card for a bank account are ubiquitous. Such payment cards are typically provided in Europe by three main operators: EuroPay; MasterCard; and Visa; hereinafter designated EMV. Additionally, other cards, herein referred to as “purchase cards” are provided which effectively charge a purchase to an account without any transfer of value at the point of obtaining the good or service, with settlement of the account occurring at a later date. Such purchase cards may be considered to be a form of account card which sets purchases against a particular account rather than making payment for a purchase. A particular example of such account cards are “fuel cards” used for the purchase of fuel by drivers of vehicles operating within a vehicle fleet, for example, and wherein settlement of the fuel purchases is performed by the owner of the fleet at some convenient time, for example at monthly intervals. The operator of the fuel card account system invoices its customers, typically the owner of the fleet, at the appropriate interval.

Use of an EMV payment card invokes a transfer of value at the time of purchase and consequently in many jurisdictions a receipt is necessary for the purchase, in particular because it contains sufficient details of the good or service purchased and the value of the purchase to check that sales tax applied to the purchase is appropriate. Conventionally, receipts are provided in paper form and it is necessary to ensure that sufficient paper is available at a payment terminal for a receipt to be issued. This is inconvenient and time-consuming for manned payment terminals. However, if a payment terminal is unmanned and particularly if it is in a remote location maintaining sufficient paper in the payment terminal to provide receipts is a significant overhead and worse still if insufficient paper is provided purchases may not be made and goods and services not dispensed depending upon local laws and regulation.

The issue of paper receipts and maintenance of paper supplies for such receipts is of particular importance in the vehicle fuel services environment. A fuel dispenser apparatus may frequently comprise a payment terminal, in particular if located in a remote and/or unmanned location. Remote locations, and in particular those which are unmanned, often have an unpleasant climate for example they may be very hot or very cold and consequently a user of the payment apparatus would prefer to be exposed to such a climate for as short a period as possible.

Aspects and embodiments in accordance with the present invention were devised with the foregoing in mind.

### SUMMARY

Viewed from a first aspect, there is provided a terminal for processing payment card data, comprising:_a tokenisation module operative to generate a token from payment card data input to the terminal, the tokenisation module complying with a security requirement for payment cards; and a registration module operative to transmit the token to a token store for storage therein, the token store not complying with a security requirement for payment cards and external to the tokenisation module.

Viewed from a second aspect, there is provided a method for processing payment card data, comprising: generating a token at a terminal from payment card data input to the terminal, wherein generating the token complies with a security requirement for payment cards; and transmitting the token to a token store for storage therein, the token store not complying with a security requirement for payment cards and external to a module for generating the token.

Typically, payment card data comprises account details such as an account number and may also include the identity of the cardholder. Such details are forbidden by the Payment Card Industry Data Security Standard (PCI DSS) from being stored in any location other than one that is compliant with the PCI DSS standard. Payment card processing modules are generally required to comply with the PCI DSS which is a particular example of a security requirement for payment cards. However, by generating a token from the payment card data the payment card data details are hidden and the token can be stored in storage which is not compliant with the PCI DSS standard. Typically, the token store is remote from and/or external to the apparatus for processing payment card data but the token may be transmitted over an open non-encrypted communications network since it does not comprise PCI data falling within the PCI DSS standard.

In an embodiment in which registration in a loyalty scheme, for example, may be initiated the provision to a user interface of a message requesting input of contact data for a user may be invoked responsive to a signal indicative of the token not being present in the external and/or remote token store. The user interface may typically be a text display but may also provide audio output. Input may be by simple keypad or audio input using voice recognition.

Typically, a message inviting the user of the apparatus to initiate a registration procedure prior to invoking provision of the message requesting input of contact data for the user is displayed on the user interface responsive to the signal indicative of the token not being present in the external and/or remote token store. Thus, a user may choose whether or not to register in a scheme.

The registration module is further operative to receive contact data for the user and initiate transmission of the contact data to the token store in order to begin registration in the scheme. Suitably, the contact data is in the form of one or other or both of an email address and a number telephone number. In particular, the contact data is a mobile telephone number. The email address and/or a mobile telephone number provide communication to a convenient communications device to which communications concerning the registration process may be sent. Furthermore, a mobile telephone is a device which a user will typically have with them and therefore the registration procedure can be initiated immediately or very soon after the procedure has been initiated. Moreover, if the mobile telephone is configured as a smartphone it may be configured to receive email.

Suitably, a network interface configured to provide communication between the apparatus and a communications network is provided.

A particularly appropriate configuration is a payment terminal configured to provide a terminal such as that described in the foregoing. Configuring a payment terminal to provide the features of the terminal described above provides the synergistic benefit of checking for registration in a loyalty programme or scheme at the same time as making a payment for goods and services and using the same apparatus without the need to build special-purpose apparatus.

Viewed from a third aspect, there is provided token store apparatus, comprising: a token store not complying with a security requirement for payment cards, the token store configured to:
store a token derived from a payment card data input to a terminal complying with a security requirement for payment cards; and
store personal data of a user of the payment card in association with the token;
and

control apparatus operative to:
receive contact data for the user of the payment card; and
initiate transmission of a message to the user of the payment card utilising the contact data, wherein the message comprises address data for providing access to the token store.

Viewed from a fourth aspect, there is provided a method for storing a token comprising: storing a token derived from payment card data in a token store not complying with a security requirement for payment cards; storing personal data of a user of the payment card in association with the token; receiving contact data for the user of the payment card; and initiating transmission of a message to the user of the payment card utilising the contact data, wherein the message comprises address data for providing access to the token store.

Suitably, the contact data stored in the token store is in the form of one or other or both of an email address and a mobile telephone number. Such contact data is particularly suitable for mobile communications because many mobile telephone devices are configured as smartphones capable of receiving email.

In a particularly effective embodiment, the address data is operative in a communications device to initiate communication with the token store apparatus. Such an embodiment makes it convenient for a user of the communications device to contact the token store.

Typically, the address data comprises a uniform resource locator (URL). The URL may be configured as a text string selectable to initiate communication with the token store apparatus. Such a text string is known as a “hot link” and activation of the hot link may be achieved by identifying the text string, such as highlighting it, and then actuating a select input. Actuation of such a “hot link” may also automatically open a web browser on the communications device.

Responsive to a communication received at an address corresponding to the address data there is provided a user interface for input of personal data. The token store is suitably connectable to the Internet and the user interface is typically provided by a web page having input regions for the personal data. Such a webpage may be accessed through the communications device via a web browser, for example a web browser automatically opened by activation of a “hot link”. Optionally, a user may use the address data for the browser of another communications device, for example a network connected personal computer, laptop, tablet or the like.

The personal data input by the user through the user interface may be stored in association with the token. Such an association may be by way of storing the personal data in a field of a token record also including a field for storing the token itself. Optionally, or additionally, the personal data together with the token may be stored in one or more tables of a relational database. The personal data may include data relating to a benefits and/or loyalty scheme.

In an optional embodiment, the token store is responsive to a match between the contact data and contact data already stored in the token store to initiate transmission of a message comprising an option to link the token with the already stored contact data. The message comprising the option to link the token with the already stored contact data may be transmitted to the communications device along with the address data. Optionally or additionally, the message comprising the option to link the token with the already stored contact data may be transmitted to and displayed at apparatus in which the token has been generated. In an optional or additional embodiment the token store may initiate transmission of a message noting that the contact data is already stored in the token store to the apparatus for processing card data. Responsive to receiving such a message the apparatus for processing card data, typically by way of the registration module, may initiate division of a message on the display to the user to opt to associate or link the two tokens/cards together.

Typically, token store apparatus comprises a network interface for communication over a communications network and forms a system comprising apparatus and token store apparatus as described above. In particular, such a system would include apparatus comprising a payment terminal.

In a typical commercial embodiment, there is provided a system comprising apparatus for processing payment card data operative to communicate with token store apparatus such as briefly described above. Such an embodiment may be considered advantageous as it could work with and utilise existing payment card systems infrastructure, in particular the token generation and encryption features at a card reader payment terminal, thereby avoiding or at least reducing capital equipment costs in building a bespoke or new system and PCI compliant infrastructure and storage.

### LIST OF FIGURES

A detailed description of one or embodiments in accordance with the invention will now be described, by way of non-limiting example only, and with reference to the accompanying drawings, in which:

FIG. 1 is a schematic illustration of an overview of a conventional payment system;

FIG. 2 is a schematic illustration of an overview of a system in accordance with an embodiment of the invention;

FIG. 3 is a process flow diagram of the overall operation of an embodiment in accordance with the invention;

FIG. 4 is a schematic illustration of a payment terminal comprising apparatus in accordance with an embodiment of the invention;

FIG. 5 is a process flow control diagram for a card reader sub-module in accordance with an embodiment of the invention;

FIG. 6 is a process flow control diagram for a registration sub-module in accordance with an embodiment of the invention;

FIG. 7 is a schematic illustration of a table structure in a relational database in accordance with an embodiment of the invention; and

FIG. 8 is a process flow control diagram for a registration sub-module in accordance with an embodiment of the invention supporting registration of a further card for an existing user.

### DESCRIPTION

Payment cards and payment card systems are well-known and indeed ubiquitous in the developed economies. Given that the systems process bank and credit card details the systems and apparatus need to be secure and payment card operators such as EuroPay, Mastercard and Visa (EMV) follow the Payment Card Industry Data Security Standard (PCI DSS) guidelines to implement security measures to reduce the loss of theft of sensitive cardholder data amongst other things. The PCI DSS guideline security measures for payment card terminals and systems include encryption of card holder data for transmission across open, public networks and in particular the Primary Account Number (PAN) is required to be stored in unreadable form utilising encryption, one-way hashing and tokenisation techniques, (see PCI DSS requirement 3.4).

In light of the PCI DSS security measures, systems and apparatus for processing and storing card holder data can be expensive to implement and maintain.

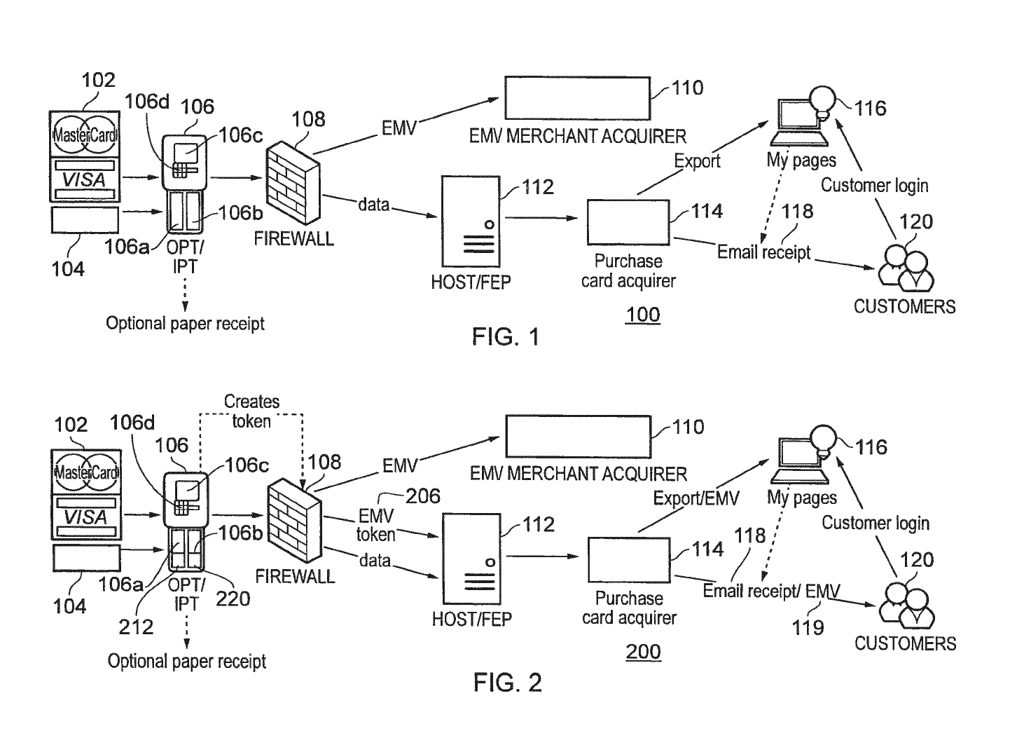

Referring now to FIG. 1, an example of a conventional card payment system 100 for a vehicle fuel services environment is schematically illustrated which is operative for EMV payment cards 102 and also purchase cards 104. A payment terminal 106 includes a card payment module 106a, a Point of Sale (POS) module 106b, a display screen 106c and a keypad 106d. The described system is for a fuel services environment and the payment terminal may be incorporated with fuel dispenser apparatus (an outside payment terminal OPT) so that a user may pay for fuel by card at the fuel dispenser apparatus. Such an arrangement may be provided for unmanned fuel dispenser apparatus. Optionally, the payment terminal 106 may be inside such as in a kiosk or shop (an inside payment terminal IPT).

The payment terminal 106 is networked to a communications network which may be a private network but typically would also include open, public telecommunications networks for long distance communications, in particular if communicating data using the Internet. The network communication is through a firewall 108 which assists in protecting the payment terminal 106 and any local network of which it may form a part from malevolent communications and attacks from outside the payment terminal 106 or local network.

The system 100 includes an EMV Merchant Acquirer 110 which is a financial services institution such as a bank and receives payment card cardholder details to effect payment for the fuel. In the described system there is also a server system 112 comprising an application server for a purchase card scheme and to which purchase card details are provided so that an invoice for fuel dispensed at the fuel dispenser apparatus may be generated or the value entered into an account for that purchase card. The server system 112 also includes electronic storage systems. Server system 112 may host a purchase scheme data processing application 114 which amongst other things may transmit transaction details to a transactions webserver 116 which may be accessed by purchase card users 120 or account managers to monitor purchases. The purchase scheme data processing application 114 may also provide electronic receipts 118 which are emailed to purchase card users 120. The purchase details transmitted to the transactions webserver 116 may be in the form of electronic receipts. A user/customer may access a webpage “my pages” 116 to view their receipts and also account information. Optionally or additionally the transaction web server 116 may provide the electronic receipt to the user/customer by email. The purchase scheme data processing application 114 may also manage a database implemented on the electronic storage systems.

The operator of the purchase card scheme can maintain a record of transactions made by respective cards in the scheme and store payment details in a manner that need not be PCI DSS compliant because such purchase card schemes do not authorise a transfer of actual value and do not fall under the PCI DSS guidelines. For example, cardholder details need not be encrypted and the storage system need not be as secure as required by the PCI DSS guidelines. As non-PCI DSS compliant systems are less complex to build and maintain they are cheaper to implement.

However, the operator of the card scheme, who in the fuel services card environment is typically also the owner/operator of the fuel dispenser apparatus, does not have information concerning fuel purchased using an EMV card. Consequently, benefits that may be offered to users of the purchase card scheme, such as discounts for volume purchases and other inducements to use the purchase card or purchase particular goods or services, cannot be provided to EMV card users based on transactions using their EMV card and using the card scheme operator's systems 112/114. If such information were to be used by the card scheme operator their systems 112/114 would have to be PCI DSS compliant with all the attendant costs of setting up and maintaining such PCI DSS compliant systems.

A system 200 implementing an embodiment in accordance with the invention is schematically illustrated in FIG. 2. Like numerals designate like parts illustrated in FIG. 1 as the context requires. The system 200 may provide for purchases using EMV cards 102 or purchase cards 104 through a payment terminal 106. The card payment module 106a includes a tokenisation sub-module 212 which comprises programmatic instructions executable to tokenise one or more elements of EMV cardholder data. The POS module 106b includes a registration sub-module 220 which comprises programmatic instructions executable for registering an EMV cardholder into a scheme which may provide purchase details, such as receipts, electronically and/or benefits such as a loyalty scheme.

The system 200 also includes a firewall 108 through which communication is made to EMV Merchant Acquirer 110 and server system 112 hosting the purchase card data processing application 114. The payment terminal 106 not only transmits EMV cardholder data or purchase cardholder data to the EMV Merchant Acquirer 110 and server system 112 respectively but also transmits a token 206 derived from one or more elements of the EMV cardholder details. EMV token 206 is generated in such a way that it is decoupled from the cardholder data from which it is derived and is therefore not required to be handled in a PCI DSS compliant manner.

EMV token 206 may be stored in the server system 112/114 with EMV cardholder data (excluding the full card account number) and processed without PCI DSS compliant procedures.

The purchase scheme data processing application 114 provides electronic transaction details to webserver 116 and/or electronic receipts 118 which are emailed to purchase card users 120 as in system 100. However, in the described embodiment EMV receipts 119 may also be provided to users 120 who paid with an EMV card by linking the token 206 with acquired cardholder details and the transaction that took place with the tokenisation.

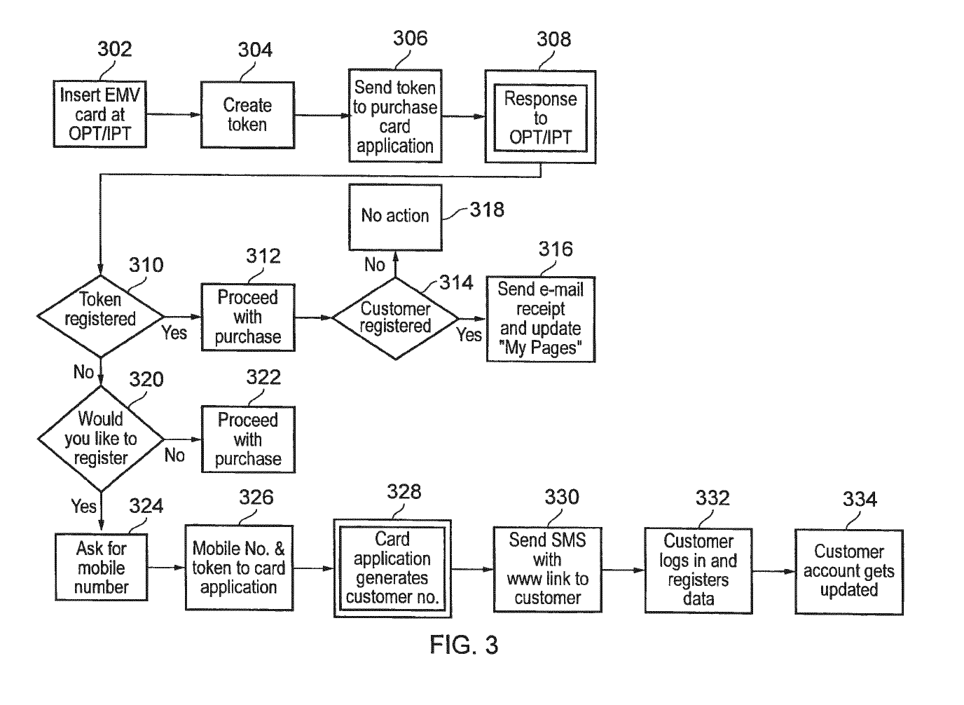

A general overview of a registration procedure 300 in accordance with an embodiment of the invention will now be described with reference to the process flow control diagram of FIG. 3.

A customer 120 inserts an EMV payment card at a payment terminal 106, step 302, and a token 206 based on the EMV payment card details is created, step 304. The token 206 is transmitted to the purchase scheme data processing application 114 on server system 112, step 306, which responds to acknowledge the transmission of the token 206, step 308.

The purchase scheme data processing application 114 then checks in the database to determine if the token 206 has already been registered, i.e. the customer is already a user, step 310, and if so sends a message to the payment terminal 106 to proceed with the purchase, step 312. The purchase scheme data processing application 114 also tests the database to determine whether a customer 120 has registered against the token 206, step 314, and if a customer 120 has registered against the token 206 sends an email receipt to the customer 120 and updates transactions webserver 116 with details of the transaction, step 316. If no customer has registered against the token 206 then no further action is taken with regard to transmission of receipts, step 318.

If at step 310 it is determined that the token 206 has not yet been registered then a message is transmitted to the payment terminal to initiate a question being presented to the user interface asking if the customer 120 would like to register the token 206, step 320, i.e. become a user. If the customer response indicates “No” then the payment terminal proceeds with the purchase without further action concerning registration, step 322. However, if the customer 120 inputs a response indicating “yes” then a request is made for the customer's 120 mobile telephone number, step 224. Following input of the mobile telephone number the mobile number and the token 206 are transmitted to the purchase scheme data processing application 114 at step 326.

The purchase scheme data processing application 114 generates a customer user identity (user ID) in response to receiving the mobile number and token 206, step 32 and sends a Short Message Service (SMS) message comprising a URL link to the purchase scheme data processing application 114 to the customer 120, step 330.

Responsive to receiving the SMS message with the URL link, the customer 120 may use the link to login to the purchase scheme data processing application 114 and register their personal data, step 332. The purchase scheme data processing application 114 account for that customer 120 is updated with the personal data and token 206, step 334. Thus, the purchase scheme data processing application 114 includes token 206 stored in association with customer personal data. Consequently transactions utilising the EMV payment card to which the token 206 corresponds may be logged against the customer personal data. This would facilitate payment receipts and account information relating to such purchases for the customer. Additionally, a purchase scheme such as a loyalty scheme may give benefits to a customer dependent upon the transactions made with the EMV payment card associated with the token 206 such as discounts or other loyalty benefits.

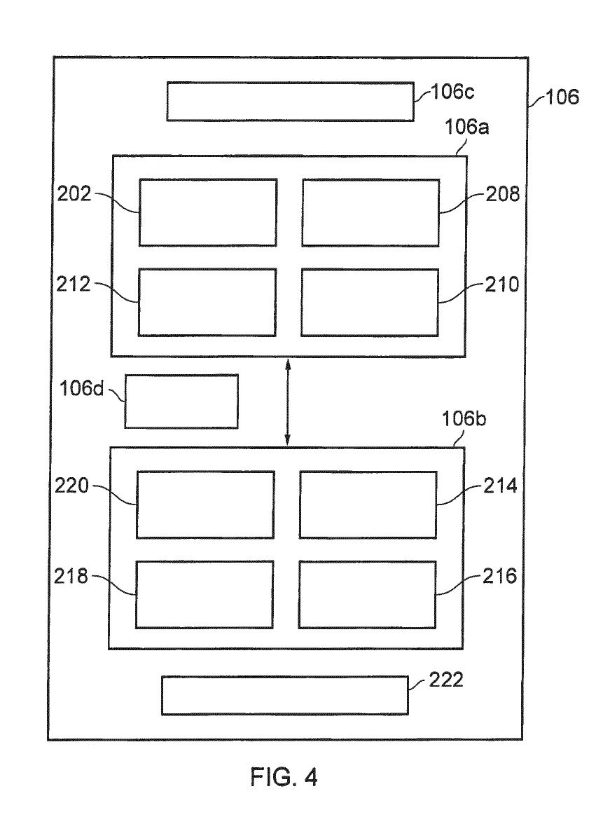

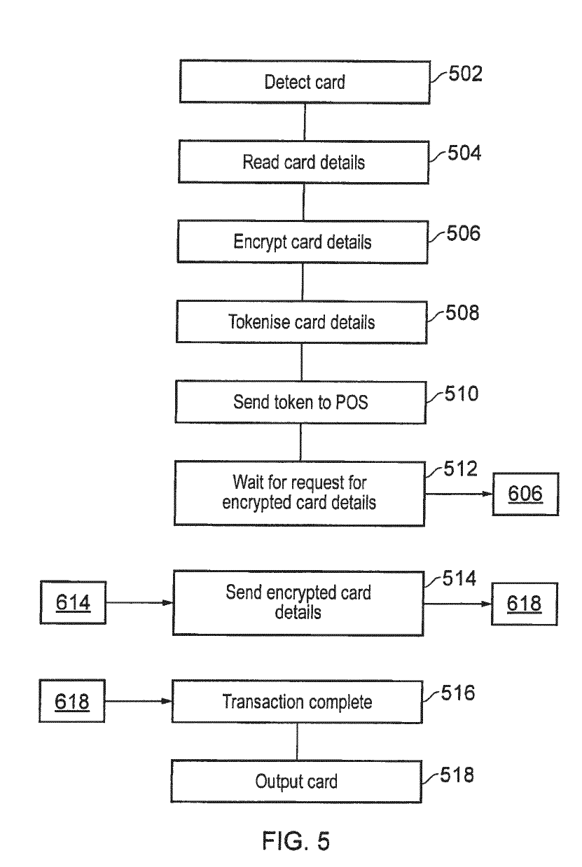

A payment terminal 106 in accordance with an embodiment of the invention will now be described with reference to FIG. 4. Payment terminal 106 includes a card reader module 106a, a registration module 106b and a display 106c. A payment terminal 106 also includes a network interface 222 for communicating with a communications network such as a private network or public telecommunications network.

Card reader module 106a includes a card reader 202 under the control of a controller 208. Typically, controller 208 comprises a microcontroller or microprocessor operative to execute programmatic instructions supplied to it. The card reader module 106a also includes a display driver 210 for supplying display signals to display 106c under the control of controller 208 during operation of the card reader 202 and other aspects of the card reader module 106a.

Card reader module 106a also includes a tokenisation sub-module 212.

In operation, an EMV payment card 102 is input into the card reader 202 and the cardholder account details read from the card under the control of controller 208. Card reader module 106a is therefore PCI DSS compliant because cardholder account details are processed within the module. Such a card reader module 106a may be referred to as a High Security Module (HSM) in PCI DSS terminology. Cardholder account details are encrypted, in particular for transmission from the card reader module 106a across an open network, within the card reader module 106a. Encryption, and possibly tokenisation, utilises cryptographic keys which are kept securely within the card reader module 106a. Cryptographic keys are supplied by the organisations who wish to encrypt the data, for example the financial institution, EMV Merchant Acquirer 110, operating a particular payment card 102. A token may be reversible or non-reversible, i.e. there is or there is not a way back to the details from which it was derived. Although for a practical matter EMV card readers may use cryptographic techniques to tokenise card details it is the case that card details may be tokenised without using cryptographic techniques. A discussion of encryption and tokenisation may be found at the following URL:

https://townsendsecurity.com/sites/default/files/Encryption vs Tokenization.pdf

In the described embodiment, the purchase scheme operator supplies a key, cryptographic or otherwise or other algorithmic parameter, for use in tokenisation sub-module 212 for generating the payment card details token 206. The cryptographic key supplied by the purchase scheme operator must be PCI DSS compliant but may be relatively easily obtainable through an existing financial services institution or EMV payment card operator already PCI DSS compliant. The tokenisation algorithm is “one way” because it is not necessary within the purchase card operator's system to be able to decrypt or reverse the token to generate the payment card details. Indeed, it is highly undesirable in the purchase scheme system to be able to decrypt or reverse the token to generate the payment card details.

The POS module 106b includes a controller 214, a display driver 216, a POS operations sub-module 218 and a registration sub-module 220. The POS module 106b is also connected to the network interface 222. The POS operations sub-module 218 provides programmatic instructions to controller 214 to implement a point-of-sale module, including amongst other things instructing display driver 216 to display information concerning a purchase such as a volume of fuel dispensed, the cost per unit fuel and the total cost of fuel dispensed, for example.

The registration sub-module 220 comprises programmatic instructions executable by controller 214 to implement the token registration process described in general outline above with reference to FIG. 3.

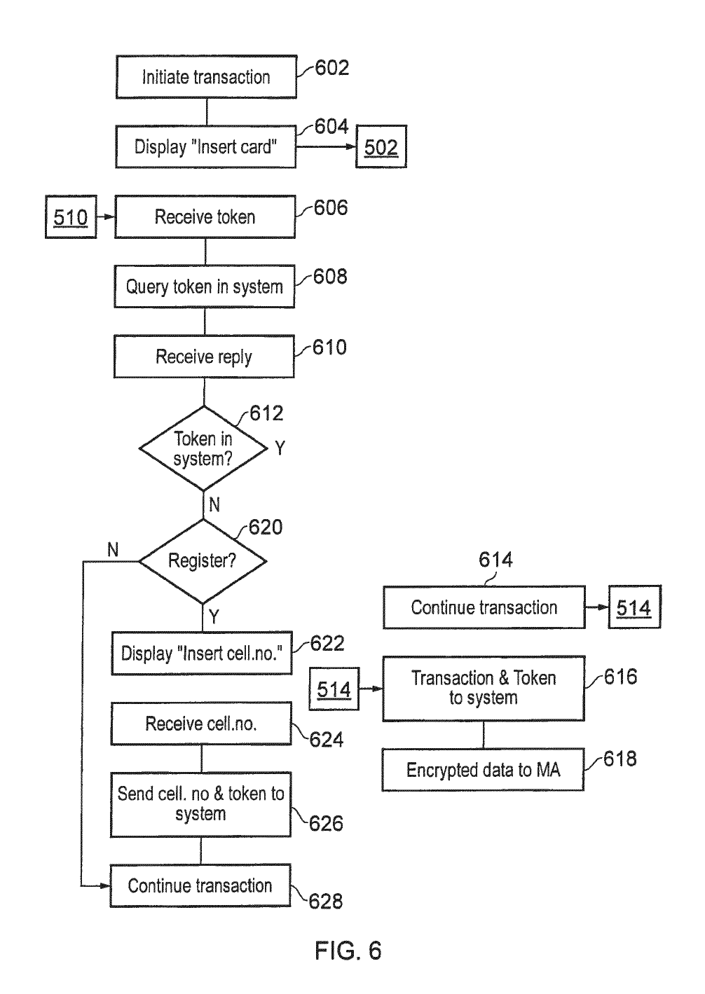

The operation of the card reader module 106a and the point of sale module 106b in accordance with an embodiment of the invention will now be described with reference to the process flow control diagrams illustrated in FIGS. 5 and 6 of the accompanying drawings. The respective sub-modules of the card reader and point-of-sale modules interact and work with each other as will now be described.

Referring now to FIG. 6, point of sale sub-module 218 provides programmatic instructions to controller 214 to initiate a transaction, step 602, by displaying on display 106c a message inviting a user to insert their payment card, step 604. Referring now to FIG. 5, process control flows to step 502 where card reader sub-module 202 provides programmatic instructions to controller 208 to detect a card input to the card reader 106a. The card reader sub-module 202 provide instructions to controller 208 to read the card details, step 504, and then encrypt the card details, step 506. As part of the encryption process, or as a separate stage, the card details are “tokenised”, step 508, responsive to instructions from the tokenisation sub-module 212. Tokenisation of the card details comprises generating a string of characters from one or more of the card details. For example, the string of characters may be generated from the cardholder account number and in general the string of characters are random or at least pseudo-random. In general, the token would be a non-reversible token because in the context of embodiments in accordance with the present invention it is not necessary to be able to reverse back to card details. Examples of how tokenisation may be used in a PCI DSS compliant environment may be found in the PCI Security Standards Council Information Supplement: PCI DSS Tokenisation Guidelines.

Controller 208 then sends the EMV token to the point of sale module 106b responsive to instructions from the tokenisation sub-module 212, at step 510. Controller 208 then waits for a request to send the encrypted card details to the point of sale module 106b, step 512. Process control then flows to step 606.

Registration sub-module 220 of the point-of-sale module 106b provides programmatic instructions for controller 214 to receive the EMV token 206 from card reader module 106a, step 606, and send a query over network interface 222 to the purchase scheme operator server 112 concerning whether or not the token already exists in the purchase scheme operator's system, step 608. Registration sub-module 220 provides instructions to controller 214 to wait for and receive a reply from the purchase scheme operator's system concerning whether or not the token already exists in the system, step 610.

At step 612 controller 214 determines whether or not the reply indicates the token is in the system or not. If the token is already in the system then process flow control proceeds to step 614 where the transaction is continued. Process control flows to step 514 where encrypted card details are sent to the POS module 106b and returns to step 616 where the transaction details and token are transferred to the purchase scheme operator's system, and then encrypted card data is transferred to the merchant acquirer 110, step 618. Process flow control then transfers to step 516 where the card reader module determines that the transaction is complete and outputs the card, step 518.

If it is determined at step 612 that the token is not already in the purchase scheme operator's system process flow control proceeds to step 620 where controller 214 is provided with instructions from registration sub-module 220 which cause a message to be displayed on the display 106c inviting the user to register with the purchase scheme operator's system. If the user inputs a response, typically via keypad 106d, declining the invitation process control flows to step 628 and the transaction continues as normal.

If the user response is to accept the invitation to register then process control flows to step 622 where controller 214 executes instructions from the registration sub-module 220 to cause display driver 216 to provide signals to display an invitation to insert mobile telephone number on display 106c, step 622. Controller 214 receives from keypad 106d the mobile telephone number input by user, step 624 and sends the mobile telephone number and EMV token 206 over network interface 222 to the purchase scheme operator's server 112.

The transaction then continues, step 628, and process control then flows to step 514 where encrypted card details are sent to the POS module 106b, which in turn transmits the encrypted card details to the merchant, step 618. Process control then flows to step 516 of the card reader module operation to complete the transaction and then the card is output from the card reader 106a, step 518.

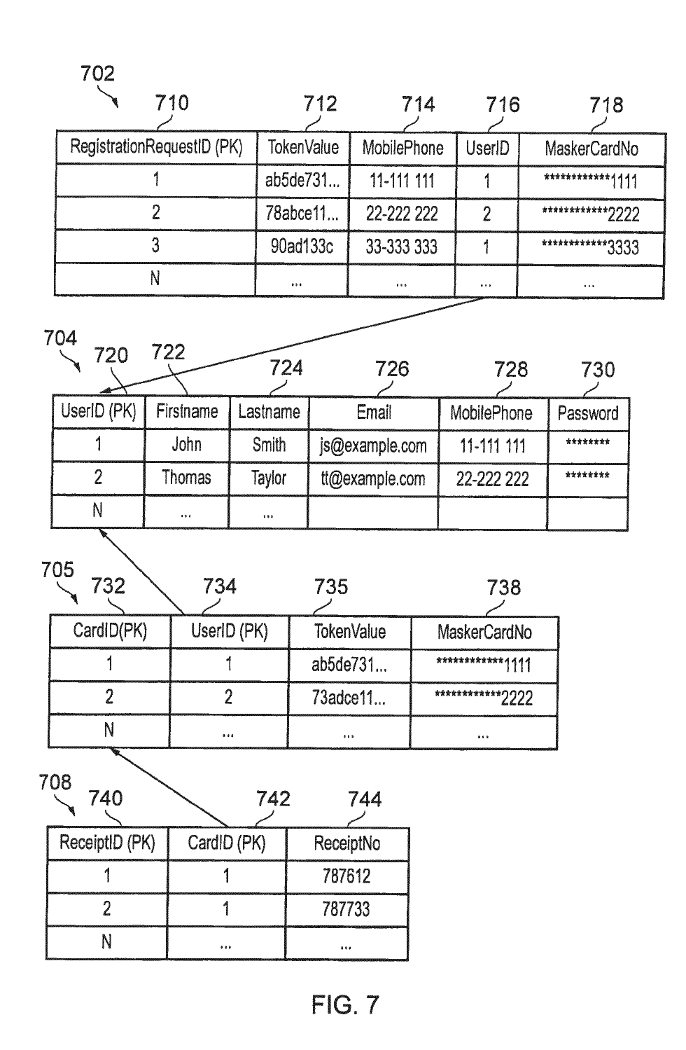

The operation of the purchase scheme application 114, in particular the database management services of the purchase scheme application 114, concerning the management of token information and the interface with a customer will now be described with reference to an example of the tables in a relational database structure in accordance with an embodiment of the present invention. Illustrated in FIG. 7 are four key tables for a database structure in accordance with the described embodiment. Each table will be referred to by its primary key. The database structure illustrated in FIG. 7 includes a registration request ID table 702, a user ID table 704, a card ID table 706 and a receipt ID table 708. The relationship between respective tables through their primary keys is illustrated by the “arrowed” lines.

Registration request ID table 702 comprises 5 columns. The first column, 710, is the registration request ID number, the second column is the, 712, the third column is the mobile phone number associated with a particular token value, 714, the fourth column is the user ID assigned to respective registration request IDs, 716 and the final column is a masked card number where only the last 4 digits of the account are visible, 718. When a registration procedure is initiated, step 602 of the process flow control diagram of FIG. 6, and the mobile telephone number and token are received by the purchase scheme application 114 running on server 112 a registration request ID is assigned to the data that is being registered. In the described embodiment, the registration request IDs are assigned in sequence, i.e. 1, 2, 3, . . . N. The token value, 206, is stored in the token value column 712 with the associated mobile telephone number stored in mobile phone column 714. A system user ID is also assigned in sequence and stored in the user ID column 716. Thus, the basic registration information is stored in the registration request ID table 702.

The purchase scheme application 114 is configured to send a text message to the mobile phone number in column 740 providing a link such as a uniform resource locator (URL) to an entry in user ID table 704, or to a webpage or other interface that allows a user to generate such an entry, in the database keyed through primary key column 720 to the user ID associated with the mobile telephone number in table 702. Through a suitable user interface, such as a webpage, the user is invited to input their first name, column 722, their last name, column 724 and their email address, column 726. The user is also invited to input a password, column 730. The mobile phone associated with the user Id is stored in column 728. Thus, the database now includes personal information of a user of the system keyed through a user ID which is also included in table 702 and associated with the token value in column 712.

Card ID table 706 includes as a primary key a card ID stored in column 732. The card ID is assigned sequentially as new token values are registered. The token of value associated with the card ID stored in column 732 is stored in column 736. Additionally, the associated user ID is stored in column 734 and is linked to the primary key of user ID table 704 thereby linking cards to users. Additionally, the masked card number is stored in column 738. In this way, all the relevant information within the system for a respective card is stored in the same table, table 706.

One of the uses to which the data stored in the database may be used by the purchase scheme application 114 is to issue receipts for transactions made against cards without requiring the card details. Receipt ID table, table 708, stores in column 740 sequentially assigned receipt ID numbers that serve as the primary key for table 708. Additionally, column 742 stores card IDs and receipt numbers are stored in column 744. Thus, a receipt generated by the purchase scheme application 140 for a particular card ID can be linked through to card ID table 706 to identify the user ID in column 734. The user ID can then be linked to table 704 through the user ID primary key of column 720. The email stored in column 726 a then be used to transmit the receipt having receipt number identified in column 744 to the correct user.

As will be evident to persons of ordinary skill in the art other tables may be utilised and indeed the tables in FIG. 7 may be expanded upon to include more columns.

For example, a card ID may be a primary key for a table monitoring the value of transactions made with that card in order to apply loyalty points based upon the value of the transactions or discounts for example. The database may be configured to have tables such that an individual user ID having multiple cards may have the value of transactions across their cards aggregated to provide greater discounts or loyalty points.

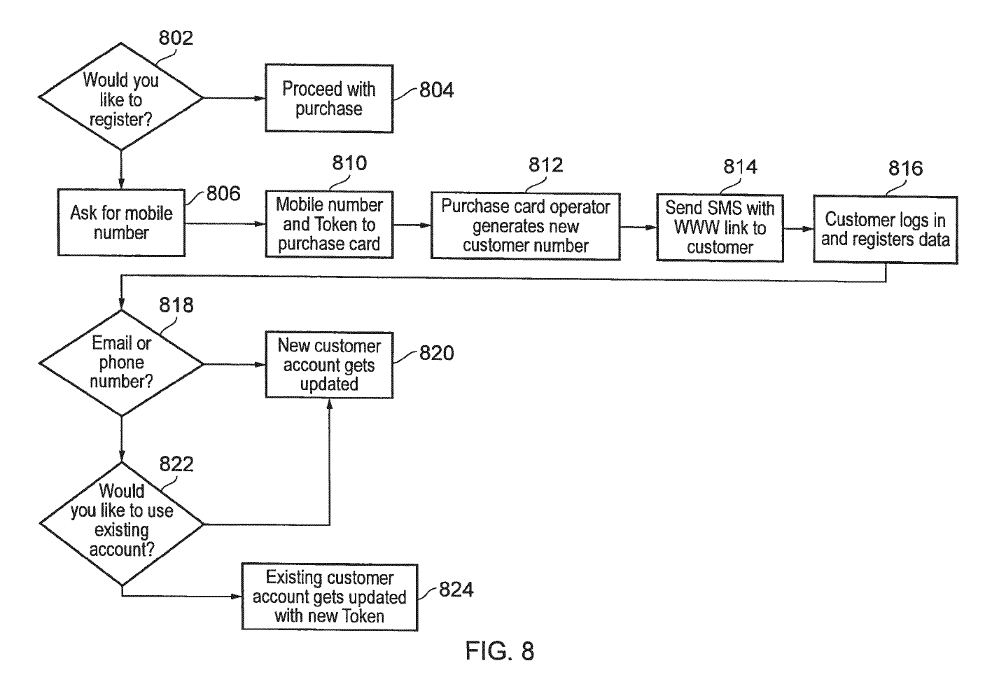

One or more embodiments may be configured to permit an existing user to register further cards to the system. An example of the operation of such an embodiment will now be described with reference to the process flow control diagram illustrated in FIG. 8 of the accompanying drawings.

As will be apparent to a person of ordinary skill in the art the steps illustrated in FIG. 8 are distributed across the card reader module, registration module and purchase card operator server illustrated in FIG. 2 for example. At an appropriate point in a transaction process, for example after a card has been inserted into the card reader, the card details are tokenised and the purchase card operator's system is interrogated for the token and if no corresponding token is found, a message is displayed asking the user if they would like to register the card inserted in the card reader. If the user responds “No”, for example pressing a designated key on a keypad or a “soft key” on a touch sensitive display, the system proceeds with the transaction procedure, step 804. If the user responds with a “Yes” then process control flows to step 806 where a message is displayed requesting the user's mobile telephone number.

The mobile telephone number input at step 806 is transmitted to the purchase card operator server together with what imay be termed a “new” token, step 810, and the purchase card operator application generates a new user (customer) ID number, step 812. An SMS message comprising a URL link is transmitted to the user's (customer's) mobile telephone at step 814.

The user/customer may activate the URL link, if it is a hot link, which automatically launches a web browser session or inputs it into a web browser to access the web page for the purchase card operator application that provides an interface for a user/customer to input their personal data for association with the new token uploaded to the application. The purchase card operator application then searches its database for one or more elements of the user/customer details just input, for example an email or telephone number, step 818. If no corresponding detail or details can be found a new user/customer account is created, step 820.

If one or more of the details are found in the purchase card operator's database then a message is displayed through the web browser asking the user/customer if they would like to use the existing account, step 822. If the user/customer answers “No” process control flows to step 820 and a new account is created for the recently uploaded token representing the new card. Otherwise, process control flows to step 824 where the existing customer account having the corresponding details is updated with the new token. In the described embodiment, the existing customer account may be updated by inserting their existing user identity into the relevant table. For example, with reference to the table structure illustrated in FIG. 7, a user makes a first registration request with a first card and then is the third registration request with a second card. Responsive to the user wishing to associate their second card with their existing account details their user ID “1” is inserted in the row corresponding to registration request ID 3 as illustrated in column 716. In this way, both the tokens for user ID 1 are linked through the user ID to the user personal details in table 704. Likewise, the card identities of table 705 may be linked to table 704.

Thus, a user/customer may link further cards to their account.

In summary and general outline the processing of EMV data requires a PCI DSS environment to ensure that sensitive financial information and the card user's identity are not compromised when making payments to a merchant. Such security and controls requires a high security IT and physical environment to operate in, which by its very nature means higher costs are placed on this type of data handling. Tokenization is a process by which the whole transaction is decoupled from the sensitive EMV data and replaced by a special and unique token number. Tokenization of such sensitive data has been widely used as a method by which secure data can be made anomalous, allowing easier processing and reduced costs. It also allows for other benefits, such as data analytics and manipulation for various added value services. However, tokenization has been usually only available in a secure PCI compliant “vault” server, and usually post transactional processing, but the Applicant has developed a novel route by which the key pad or POS terminal may act as a pre-acquiring tokenization tool, but under PCI compliance. The terminal is modified by additional instructions to act as a simple, secure and cheap tokenization tool, thus allowing existing tokenization keys to be deposited away from the “vault” but using the terminal's inherent PCI compliance to ensure EMV transactions are transmitted to the acquirer and tokenized data to the merchant or purchase card operator in one secure environment . This means that the terminal is acting as a relatively cheap, easy to implement and secure user interface for tokenization of data prior to sending to the acquiring parties for secure processing. The merchant or purchase card operator may then gain insights into the EMV transactions previously unknown to them.

Insofar as embodiments of the invention described above are implementable, at least in part, using a software-controlled programmable processing device such as a general purpose processor or special-purposes processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present invention. The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. A skilled person would readily understand that term “computer” in its most general sense encompasses programmable devices such as referred to above, and data processing apparatus and computer systems in whatever format they may arise, for example, desktop personal computer, laptop personal computer, tablet, smart phone or other computing device.

Suitably, the computer program is stored on a carrier medium in machine readable form, for example the carrier medium may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD) subscriber identity module, tape, cassette solid-state memory. The computer program may be supplied from a remote source embodied in the communications medium such as an electronic signal, radio frequency carrier wave or optical carrier waves. Such carrier media are also envisaged as aspects of the present invention.

As used herein any reference to “one embodiment” or “an embodiment” means that a particular element, feature, structure, or characteristic described in connection with the embodiment is included in at least one embodiment. The appearances of the phrase “in one embodiment” or the phrase “in an embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

In view of the foregoing description it will be evident to a person skilled in the art that various modifications may be made within the scope of the invention. For example, although an embodiment of the invention has been described with reference to a payment terminal 106 having a single controller implementing separate card reader module 106a and point-of-sale module 106b with respective controllers and display drivers 208/210 and 214/216 it will be evident to a person of ordinary skill in the art that the separate modules, controllers and display drivers may be combined into a single module, controller and display driver. Indeed, the display driver need not be a separate module from the controller.

Additionally, the functions of the tokenisation sub-module 212 and registration sub-module 220 may be integrated with one or more controllers. Furthermore, although tokenisation is generally considered to comprise a non-predictable, one-way, irreversible function to generate a string of characters from initial data which generally excludes encryption because encryption involves use of a key for decryption it will be evident to a person of ordinary skill in the art that encryption techniques could be used in the tokenisation process and indeed a reversible encryption algorithm could be utilised to generate a token which could be used in one or more embodiments of the present invention. Consequently, the term “tokenisation” and related and derived terms are not limited to embodiments in which the token character string is generated in irreversible random or pseudorandom way but may include a token character string been generated using an encryption algorithm.

The terms “customer” and “user” may refer to the same person where a purchaser of a good or service is also a user of the purchase card system. Optionally, the term “customer” may refer to a purchaser of a good or service not a user, or not yet a user, of the purchase card system. Likewise, the term “user” may be used to refer to a person who is a member of the purchase card system when they are making a purchase using an EMV card and not a purchase scheme card. Consequently, the terms “customer” and “user” may be used interchangeably or to refer to different categories of person depending upon the context as appropriate. The terms “customer” and “user” are not intended to unduly limit the scope of the disclosure or appended claims and they should be construed in accordance with the context in which they are used.

Although embodiments of the invention have been described with reference to mobile telephone numbers being input to a POS other or additional suitable contact details may be used such as an email address. Additionally, the terms “card details” and “card data” are used interchangeably and are intended to refer to the same thing unless the context requires otherwise.

The completion of registration details by inputting personal data may be performed immediately following the transaction initiating registration, for example through a web browser provided on a smart phone. However, it is likely to be done at a later time at the user's convenience.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

1-46. (canceled)

47. A terminal for processing payment card data, comprising:
a tokenisation module operative to generate a token from payment card data input to the terminal, the tokenisation module complying with a security requirement for payment cards; and
a registration module operative to transmit the token to a token store for storage therein, the token store not complying with a security requirement for payment cards and external to the tokenisation module;
optionally wherein the security requirement for payment cards comprises complying with the payment card industry data security standard (PCI DSS).

48. The terminal of claim 47, wherein the registration module is further operative to be responsive to a signal indicative of the token not present in the external/remote token store to evoke the provision to a user interface of a message requesting input of contact data for a user.

49. The terminal of claim 48, wherein the registration module is further operative to be responsive to the signal indicative of the token not present in the external/remote token store to invoke the provision to a user interface of a message inviting the user of the apparatus to invoke a registration procedure prior to initiating provision of the message requesting input of contact data for the user.

50. The terminal of claim 48, wherein the registration module is further operative to receive contact data for the user and initiate the transmission of contact data to the token store.

51. The terminal of claim 50, wherein the registration module is operative to receive contact data in the form of either or both of an email address or a mobile telephone number;
optionally further comprising a network interface configured to provide communication between the apparatus and a communications network.

52. A card payment terminal, configured to provide a terminal according to claim 47.

53. A token store apparatus, comprising:
a token store not complying with a security requirement for payment cards, the token store operative to:
store a token derived from a payment card data input to a terminal complying with a security requirement for payment cards; and
store personal data of a user of the payment card in association with the token; and
a control apparatus operative to:
receive contact data for the user of the payment card; and
initiate transmission of a message to the user of the payment card utilising the contact data, wherein the message comprises address data for providing access to the token store;
optionally wherein the contact data is in the form of either or both of an email address or a mobile telephone number.

54. The token store apparatus of claim 53, wherein the address data is operative in a communications device to initiate communication with the token store apparatus.

55. The token store apparatus of claim 54, wherein the address data comprises a uniform resource locator (URL).

56. The token store apparatus of claim 55, wherein the uniform resource locator is configured as a text string selectable to initiate communication with the token store apparatus.

57. The token store apparatus of claim 54, wherein the control apparatus is further operative to be responsive to a communication received at an address corresponding to the address data to provide to the communications device a user interface for input of personal data;
optionally wherein the control apparatus is further operative to store the personal data input through the user interface in association with the token; and
optionally wherein the personal data may include data relating to a benefits and/or loyalty scheme.

58. The token store apparatus of claim 53, wherein the control apparatus is further operative to be responsive to a match between the contact data and contact data already stored in the token store to initiate transmission of a message comprising an option to link the token with the already stored contact data.

59. The token store apparatus of claim 58, wherein the control apparatus is further operative to be responsive to a communication indicative of selection of the option to link the token with the already stored contact data to store the token in association with the already stored contact data.

60. The token store apparatus of claim 53, wherein the control apparatus is further operative to be responsive to a match between the contact data and contact data already stored in the token store to initiate transmission of a message comprising an option to link the token with an already stored token associated with the already stored contact data.

61. The token store apparatus of claim 60, wherein the control apparatus is further operative to be responsive to a communication indicative of a selection of the option to link the token with an already stored token to store the token in association with the already stored token.

62. The token store apparatus of claim 53, comprising a network interface for communication over a communications network.

63. A system, comprising:
a terminal for processing payment card data, comprising:
a tokenisation module operative to generate a token from payment card data input to the terminal, the tokenisation module complying with a security requirement for payment cards; and
a registration module operative to transmit the token to a token store for storage therein, the token store not complying with a security requirement for payment cards and external to the tokenisation module;
optionally wherein the security requirement for payment cards comprises complying with the payment card industry data security standard (PCI DSS); and
a token store apparatus, comprising:
a token store not complying with a security requirement for payment cards, the token store operative to:
store a token derived from a payment card data input to a terminal complying with a security requirement for payment cards; and
store personal data of a user of the payment card in association with the token; and
a control apparatus operative to:
receive contact data for the user of the payment card; and
initiate transmission of a message to the user of the payment card utilising the contact data, wherein the message comprises address data for providing access to the token store;
optionally wherein the contact data is in the form of one or other or both of an email address and a mobile telephone number.

64. The system according to claim 63, wherein the terminal for processing payment card data comprises a payment terminal.

65. A method of processing payment card data, comprising:
generating a token at a terminal from payment card data input to the terminal, the tokenisation module complying with a security requirement for payment cards; and
transmitting the token to a token store for storage therein, the token store not complying with a security requirement for payment cards and external to a module for generating the token.

66. The method of claim 65, further comprising:
responding to a signal indicative of the token not present in the external/remote token store to invoke the provision to a user interface of a message requesting input of contact data for a user; and
optionally responding to the signal indicative of the token not present in the external/remote token store to invoke the provision to a user interface of a message inviting the user to invoke a registration procedure prior to initiating provision of the message requesting input of contact data for the user.

67. The method of claim 66, further comprising:
receiving contact data for the user and initiating transmission of the contact data to the token store.

68. The method of claim 67, further comprising:
receiving contact data in the form of one or other or both of an email address and a mobile telephone number.

69. The method of claim 68, wherein the security requirement for payment cards comprising complying with the payment card industry data security standard (PCI DSS).

70. A method of storing a token, comprising:
storing a token derived from a payment card data in a token store not complying with a security requirement for payment cards;
storing personal data of a user of the payment card in association with the token;
receiving contact data for the user of the payment card; and
initiating transmission of a message to the user of the payment card utilising the contact data, wherein the message comprises address data for providing access to the token store;
optionally wherein the contact data is in the form of one or other or both of an email address and a mobile telephone number.

71. The method of claim 70, further comprising:
initiating communication with the token store using the address data.

72. The method of claim 71, wherein the address data comprises a uniform resource locator (URL).

73. The method of claim 72, wherein the uniform resource locator is configured as a text string selectable to initiate communication with the token store;
optionally further comprising responding to a communication received at an address corresponding to the address data to provide to the communications device a user interface for input of personal data, and storing the personal data input through the user interface in association with the token, wherein the personal data includes data relating to a benefits and/or loyalty scheme.

74. The method of claim 70, further comprising:
responding to a match between the contact data and contact data already stored in the contact store to initiate transmission of a message comprising an option to link the token with the already stored contact data.

75. The method of claim 74, further comprising:
responding to a communication indicative of selection of the option to link the token with the already stored contact data to store the token in association with the already stored contact data.

76. The method of claim 70, further comprising:
responding to a match between the contact data and contact data already stored in the token store to initiate transmission of a message comprising an option to link the token with an already stored token associated with the already stored contact data.

77. The method of claim 76, further comprising:
responding to a communication indicative of selection of the option to link the token with an already stored token to store the token in association with the already stored token.
